(19) United States
(12) Patent Application Publication
(10) Pub. No.: US 2012/0067951 A1
(43) Pub. Date: Mar. 22, 2012

(54) Management and Weapon Operation System for Support to Military Management Processes

(75) Inventor: Volker HACKMANN, Grasberg (DE)

(73) Assignee: Atlas Elektronik GmbH, Bremen (DE)

(21) Appl. No.: 13/237,274

(22) Filed: Sep. 20, 2011

(30) Foreign Application Priority Data
Sep. 21, 2010 (DE) 10 2010 046 200.4

(51) Int. Cl. G06F 19/00

(52) U.S. Cl. 235/400

(57) ABSTRACT

A management and weapon operation system for support to military management processes, which has interfaces to at least one sensor and at least one effector. The system can be controlled via a graphic control interface 2 that can be displayed on at least one display device for mutual communication between a user and the system. For simple configuration of the system and for reuse of individual applications, the graphic control interface 2 is broken down into individual fragments 8. These are integrated in a desktop manager 4, which carries out the process control for the management and weapon operation system. The fragments 8 have a standard desktop interface 10 for integration. The fragments 8 furthermore have a user interface 12 for communication via an intermediate application 22 with the sensors and/or effectors. The invention also relates to a method for configuration of a management and weapon operation system.

### CROSS-REFERENCE TO RELATED APPLICATION

The present application claims the priority of German Patent Application No. 10 2010 046 200.4, filed Sep. 21, 2010, the subject matter of which, in its entirety, is incorporated herein by reference.

### BACKGROUND OF THE INVENTION

The invention relates to a management and weapon operation system for support to military management processes, which has interfaces to at least one sensor and at least one effector and has a graphic control interface that can be displayed on at least one display device for mutual communication between a user and the management and weapon operation system. The invention additionally relates to a method for the configuration of a management and weapon operation system via a graphic control interface, wherein the management and weapon operation system has interfaces to at least one sensor and at least one effector, and wherein the control interface (2) can be displayed on at least one display device for mutual communication between a user and the management and weapon operation system.

Management and weapon operation systems are complex systems by means of which the tactical and operative operation is carried out. Because of their operative capabilities, systems such as these are used in the course of operations, exercises, maneuvers, etc., and normally comprise real-time components as well as planning and management aids. Management and weapon operations systems such as these are known, for example, from defense technology.

In order to support military management processes, the management and weapon operation system has a control program by means of which effectors can be operated and/or measurement results from connected sensors, in particular radar and/or sonar, can be evaluated and interpreted, and/or data can be interchanged with at least one further communication subscriber in the system.

The achievement of these objects requires, inter alia, a graphic control interface for interactive display, with a real-time capability, on a display means, in particular a control console, for a user to operate the management and weapon operation system. The management and weapon operation system furthermore requires individual interfaces, some with a real-time capability, to sensors, effectors and communication systems, whose combination, for example for a Navy system, differs greatly from one vessel to another, and therefore from one project to another, however.

Normally, the Navy has various watercraft which have different sensors and effectors. There are a plurality of control consoles onboard such watercraft, on which associated operators carry out the roles assigned to them. However, these roles may vary depending on the various operations of the watercraft. For example, an exercise simulation or battle simulation requires a different role distribution on the control consoles than, for example, when the watercraft is carrying out reconnaissance.

The control console has a graphic control interface for mutual communication between the operator and the management and weapon operation system. Changing operational scenarios of the watercraft also require changing roles for the operators on the control consoles. Conventionally, this control interface is reprogrammed for each project, with considerable programming effort. However, displaying all the feasible roles on the graphic control interface would disadvantageously make the control process more difficult, and would lead to considerable lack of clarity.

Since the sensors and effectors are procured from different manufacturers and the watercraft as such are also obtained from yet other manufacturers, this normally results in specific graphic control interfaces for controlling the management and weapon operation system for each vessel, and these control interfaces are matched to the equipment in the vessel. Conventionally, this control interface is reprogrammed for each vessel type and for each functional configuration of the vessel, with considerable programming effort.

The prior art for integration of various sensors and effectors in the management and weapon operation system is defined by project-driven creation of interface couplings between the systems to be integrated.

DE 197 41 959 A1 discloses a distributed data processing system which is controlled by a central control module. First means are stored for this purpose in the control module and characterize technical states in a technical process. Furthermore, second means are stored and are used to associate controller modules with the first means. Furthermore, the control module has third means, which enable a data object when the technical state which is characterized by the first means and the data object matches, and fourth means, which after enabling of a data object, activate the controller module which corresponds to the characterizing technical state.

Against this background, the invention is based on the problem of providing a management and weapon operation system which has one or more graphic control interfaces for rapid and cost-effective creation of a management and weapon operation system such as this, and which furthermore allows the system to be rapidly matched to and configured for changing roles and/or operational scenarios.

### SUMMARY OF THE INVENTION

The invention generally solves the above problem by a management and weapon operation system according to the invention, and by the features of a corresponding method for configuration of a management and weapon operation system according to the invention.

A management and weapon operation system for support to military management processes accordingly has interfaces to at least one sensor and at least one effector. Furthermore, a management and weapon operation system such as this can be controlled via a graphic control interface, wherein the control interface can be displayed on at least one display means, in particular a control console, for mutual communication between at least one user and the management and weapon operation system.

Graphic control interfaces on the one hand carry out the function of displaying elements and information on a screen. On the other hand, they must allow actions to be carried out which are initiated by the operator on the control interface.

A desktop manager, which carries out the process control of the management and weapon operation system, is used as the basis for the graphic control interface. A plurality of fragments are integrated in this desktop manager during the running time of the management and weapon operation system, thus advantageously resulting in the graphic control interface having a modular design. For this purpose, the fragments each have a desktop interface via which the desktop manager stimulates and manages the fragments. Furthermore, the fragments each have a user interface for communication between the fragment and at least one server.

By means of a dialog algorithm of embedded fragments, the desktop manager then takes advantage of the running control or the process control of the management and weapon operation system.

The fragments are individual modules which have standardized components and have application logic for specific system aspects. Furthermore, the fragments are used to standardize interfaces and to generalize methods, in such a way that individual applications appear to be standard to the user.

The modular design of the control interface of the management and weapon operation system results in the advantage that different sensors and effectors can be combined as required and as desired by the customer, at low cost and with little effort. The display of control elements and the control of functions of systems which are networked with one another are configured, according to the invention, so as to allow even components which are added retrospectively to be controlled in a simple manner.

In one preferred embodiment of the invention, the desktop interfaces of the fragments are all standard. The fragments are therefore all stimulated in the same manner by the desktop manager, to be precise independently of what part of the control interface they implement. The fragments can therefore be included in the desktop manager by on-line configuration or by so-called “drag and drop”, and are identified automatically, and integrated in the process, by the desktop manager.

In a further preferred embodiment of the invention, the user interfaces of the fragments are designed such that the fragments represent interchangeable adapters for different servers.

In this case, a server means a program which communicates with another program in order to provide it with access to specific services. Application-neutral programs such as these, referred to in the following text as intermediate applications (Middleware) act between applications in such a way that the complexity of this application and its infrastructure remain concealed. The intermediate application provides so-called services in the run-time environment, which can be accessed by means of specific programming interfaces. The intermediate application defines the logic macro of the interaction between partners and distributed systems, such that the original infrastructure of the application itself remains concealed. This therefore allows communication between otherwise decoupled software components.

The intermediate application software is available as standard software from a number of manufacturers. The user interfaces of the fragments achieve abstraction from the intermediate application, thus advantageously achieving a high level of flexibility in the combination of the system components of the management and weapon operation system.

According to a further embodiment of the invention, the management and weapon operation system has a library in which a plurality of macro solutions can be stored. In this case, one or more fragments from a macro solution such as this, which also predetermines how the interfaces of the fragments communicate with one another and which can advantageously be found as a reusable macro in the library.

From the configuration of the management and weapon operation system, the library advantageously provides a rapid overview of already existing macro solutions which provide the desired functionality.

In a further embodiment, the fragments are designed such that they have the layout information for displaying their specific task via the graphic control interface on the display means. Therefore, individual applications in the management and weapon operation system have a standard appearance. This makes it easier for an operator to find his way with changing systems and/or roles and/or operational scenarios when operating the management and weapon operation system.

In a further preferred embodiment of the invention, the fragments are designed such that they have logic elements and interfaces to form an intrinsically closed unit. Furthermore, the fragments form a functionally closed control aspect. This has the advantage that the individual fragments can be tested and accepted separately.

According to a further embodiment of the invention, the fragments which are managed by the desktop manager have at least one control element, which is required to control the management and weapon operation system. However, the control elements are preferably “OK”, “Apply”, “Cancel” and/or “Reset”. Since the desktop manager with the fragments represents the basis of the graphic control interface, this advantageously results in the graphic control interface having a standard appearance.

In a further embodiment of the invention, the desktop manager is designed such that it can manage and stimulate the integrated fragments. The desktop manager can therefore advantageously carry out process control for the management and weapon operation system.

According to a further advantageous embodiment of the invention, the desktop manager is designed such that it can be connected to the application-neutral program which is used as the server. The application-neutral program is preferably the so-called intermediate application. The application can therefore be controlled externally and is able to communicate via the intermediate application with the appliances which are integrated in the system.

In a corresponding method for configuration of the management and weapon operation system via one or more graphic control interfaces, at least a new desktop manager is created and/or at least an already existing desktop manager is selected. This desktop manager represents the basis for the graphic control interface, and is connected to a server which can be used. At least one fragment, which has a dialog algorithm, for construction of the graphic control interface is then integrated in the desktop manager, wherein the fragments can be integrated in the desktop manager during the running time of the management and weapon operation system. The matching and recombination of the graphic control interface are possible, for example, during maintenance operation relating to the running time.

The included or integrated fragments are managed by the desktop manager and are stimulated via a desktop interface. Therefore the process control of the management and weapon operation system is carried out by means of the desktop manager, using the included fragments with their dialog algorithm.

A method such as this for configuration of the management and weapon operation system makes it possible to match the control interface to changing roles and operational scenarios. This is advantageous because the role distribution onboard a watercraft is normally not of a static character. Furthermore, the complexity is reduced because of the lack of monolithic structures for the configuration of management and weapon operation systems such as these.

In a further embodiment of the invention, the procedure of the management and weapon operation system is output by means of a functional display via the graphic control interface on the display means. Since this display can be updated in real time, an operator can advantageously react in real time.

Further advantageous embodiments of the invention will become evident from the dependent claims and from the exemplary embodiments which will be explained in more detail with reference to the attached drawing.

### BRIEF DESCRIPTION OF THE DRAWINGS

FIG. 1 shows a schematic configuration of the graphic control interface.

FIG. 2 shows a schematic configuration of the desktop manager.

### DETAILED DESCRIPTION OF THE INVENTION

The exemplary embodiment of the invention, as explained in the following text, relates to a management and weapon operation system for the Navy. However, the invention is not restricted to a management and weapon operation system such as this for the Navy, but can also be used, for example, in the Air Force or for the Army.

One important aspect of the invention is the reusability and the simple configurability of the software to be developed for a management and weapon operation system. For this purpose, the graphic control interface for controlling the management and weapon operation system is broken down into individual fragments and is displayed to an operator of the management and weapon operation system on a display means, in particular a control console.

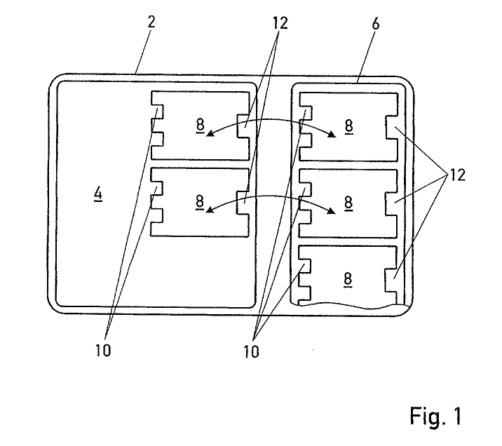

FIG. 1 shows a schematic configuration of a graphic control interface 2 such as this. A desktop manager 4 and, possibly, a library 6 are required to construct this control interface 2.

Individual fragments 8 for construction of the graphic control interface 2 are integrated in the desktop manager 6. These fragments 8 have a functional aspect of the control of an appliance connected to the management and weapon operation system, or of a system context.

By way of example, an appliance connected to the management and weapon operation system is a sensor or an effector.

The fragments 8 can either be reprogrammed or can be taken from the library 6. The library 6 contains a list of all the available macro solutions. The choice of a macro solution results in the associated fragments 8 or the fragment 8 being integrated in the desktop manager 4.

In order to integrate the fragments 8 in the desktop manager 4, the fragments 8 have a standard desktop interface 10, and are thus inserted into a generic process framework of the overall application of the management and weapon operation system. All the fragments 8 are stimulated in the same way via this desktop interface 10, to be precise independently of what part of the control interface 2 they implement. They can therefore be integrated in the desktop manager 4 on the “Plug and Play” principle, and are automatically identified by the desktop manager 4 and included in its management, without the entire system having to be adapted. It is therefore possible to react to customer wishes cost-effectively, because of the flexible, configurable layout. From the development point of view, this results in greater productivity in the production of graphic control interfaces 2.

Furthermore, the fragments 8 have an individual user interface 12 for communication interchange between the fragment 8 and at least one server or intermediate application.

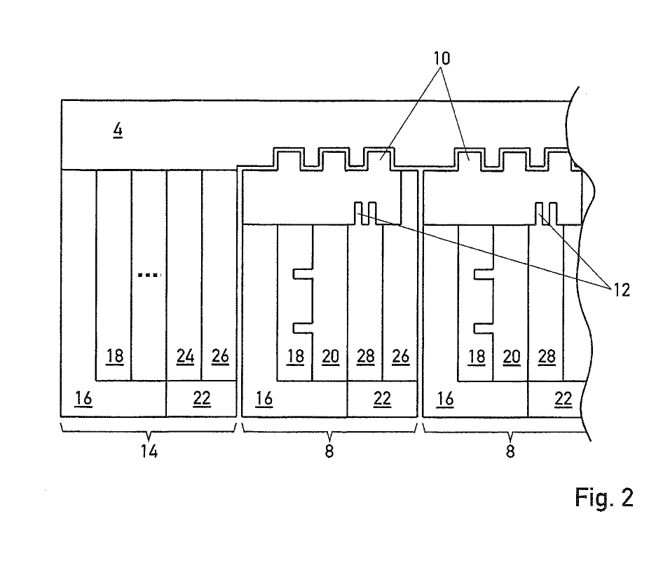

FIG. 2 shows a schematic configuration of the desktop manager 4, in which a fragment 14 has already been integrated on the left-hand side, followed by two further fragments 8 to be integrated.

The desktop manager 4 provides standardization for the graphic configuration of all the control interfaces 2. Together with the fragments, in addition to the necessary control elements or key areas, such as “OK”, “Apply”, “Cancel” and/or “Reset”, it provides the entire infrastructure which is required for controlling the generic dialog algorithm, and acts as a container for the fragments 8 by managing them and stimulating them via the desktop interface 10. The desktop manager 4 carries out the process and sequence control of the management and weapon operation system using the integrated fragments, with their generic dialog algorithm.

For configuration of the management and weapon operation system, the fragments 8 can be combined on a project-specific basis, and integrated in the desktop manager 4, without any programming effort.

In this case, the term configuration means both reconfiguration of a management and weapon operation system and the reconfiguration of an already existing management and weapon operation system.

The fragments 8 have a standard component configuration and are produced by means of an already known programming language 16. In this case, the components should as far as possible be designed such that they can be linked to other components and then used automatically, without any need for further programming.

The components may be layout information, such as a visual framework with inscriptions for optical structuring of the fragment 8 and/or input components and/or output components. Furthermore, the fragments 8 contain the implementation of the user interface application 12 for the respective appliance associated with the corresponding task of the fragment 8. A fragment 8 therefore implements a functionally closed control aspect, which may have any desired level of granularity. The fragments 8 are therefore units which can also be reused in other desktop managers 4 with little integration effort. Furthermore, these fragments 8 can be tested and accepted separately.

Each fragment 8, which allows the input of data, is itself responsible for checking the data. The data check is therefore implemented only once by the developer. The response of the fragment 8 to incorrect inputs is therefore standardized. This data check is implemented in a basic component 18, which initially represents a visual component which is used for data input and output.

Furthermore, the fragments 8 have a converter component 20, for conversion of technical units.

One precondition for the production of a new application for the management and weapon operation system is the link to the intermediate application 22. This allows the application to be controlled externally. The remote control capability is achieved, for example, by the use of two so-called “Plug and Play” components in the fragments 8, which represent the application externally. These components are, on the one hand, a service component 24 in order to make the application known to the intermediate application 22 and, on the other hand, a display component 26 for controlling the visibility, selection capability and position.

The content of a fragment 8 covers a server aspect and provides a defined server functionality with a user interface 12 in an individual interface component.

The fragment 8 is stimulated by the desktop manager 4 in which it is integrated as soon as a user has pressed one of the standard buttons, and must react in a sensible manner to this stimulation. Therefore, the fragments 8 represent interchangeable adapters for different intermediate applications 22. The user interfaces 12 of the fragments 8 for the intermediate application 22 are encapsulated via the interface component 28, in order to allow the intermediate application 22 to be replaced, if required. The training effort for employees is reduced by concealing the complexity of the intermediate application 22 that is used.

The fragments 8 are integrated in the desktop manager 4 depending on the requirement for the graphic control interface 2. The initially mentioned role distribution onboard a watercraft may necessitate adapted graphic control interfaces 2. Since the provision of a specific role response for an application is a functionality of the intermediate application 22 to be used, the fragments 8 have the display component 26, which implements response control from the exterior. The sensitivity of the control elements of the desktop manager 4 can therefore be controlled as a function of the selected role.

All of the features mentioned in the above description of the figures, in the claims and in the introductory part of the description can be used both individually and in any desired combination with one another. The disclosure of the invention is therefore not restricted to the described and/or claimed feature combinations. In fact, all feature combinations shall be considered to have been disclosed.

1. Management and weapon operation system for support to military management processes, which has interfaces to at least one sensor and at least one effector and can be controlled via at least one graphic control interface (2), wherein the control interface (2) can be displayed on at least one display means for mutual communication between a user and the management and weapon operation system,
further comprising
at least one desktop manager (4) which is designed to be used as the basis for the graphic control interface (2),
a plurality of fragments (8) for construction of the graphic control interface (2), wherein the fragments (8) have a dialog algorithm and are included in the desktop manager (4), a desktop interface (10), which is designed to include the fragment (8) in the desktop manager (4), wherein the fragments (8) can be integrated in the desktop manager (4) during the running time of the management and weapon operation system,
a further refinement of the fragments (8), each having a user interface (12), which is designed to allow communication between the fragment (8) and at least one server (22), a refinement of the desktop manager (4) to manage the fragments (8) which are included or integrated in the desktop manager (4) via the desktop interface (10) and to stimulate them via the desktop interface (10), and
a further refinement of the desktop manager (4), in order to carry out the process control of the management and weapon operation system using the fragments (8) which are included, with their dialog algorithm.

2. Management and weapon operation system according to Claim
wherein
the desktop interfaces (10) of the fragments (8) are all standard.

3. Management and weapon operation system according to claim 1,
wherein
the user interfaces (12) of the fragments (8) are designed such that the fragments (8) represent interchangeable adapters for different servers (22).

4. Management and weapon operation system according to claim 1,
wherein
the at least one server (22) being in the form of an application-neutral program, in particular an intermediate application, for data interchange between the fragments (8) and associated sensors and/or effectors.

5. Management and weapon operation system according to claim 1,
further including
a library (6) in which a plurality of macro solutions can be stored, wherein one or more fragments (8) form a macro solution.

6. Management and weapon operation system according to claim 1,
wherein
the fragments (8) are designed such that they have the layout information for displaying their specific task via the graphic control interface (2) on the display means.

7. Management and weapon operation system according to claim 1,
wherein
the fragments (8) are designed such that they have logic elements and interfaces to form an intrinsically closed unit and to provide a functionally closed control aspect.

8. Management and weapon operation system according to claim
further including
control elements for the fragments (8) which are managed by the desktop manager (4), which control elements are required to control the management and weapon operation system.

9. Management and weapon operation system according to claim 1,
wherein
the desktop manager (4) is designed to manage and to stimulate the integrated fragments (8).

10. Management and weapon operation system according to claim 1,
wherein
the desktop manager (4) is designed such that it can be connected to the application-neutral program, in particular an intermediate application, which is used as the server (22).

11. Method for the configuration of a management and weapon operation system via at least one graphic control interface (2), wherein the management and weapon operation system has interfaces to at least one sensor and at least one effector, and wherein the control interface (2) can be displayed on at least one display means for mutual communication between a user and the management and weapon operation system,
wherein
at least one new desktop manager (4) is created and/or at least one existing desktop manager (4) is selected, wherein the desktop manager (4) is used as the basis for the graphic control interface (2), the desktop manager (4) is connected to a server (22), in particular an intermediate application, which can be used,
at least one fragment (8), which has a dialog algorithm, is included in the desktop manager (4) for construction of the graphic control interface (2), wherein the fragments (8) can be integrated in the desktop manager (4) during the running time of the management and weapon operation system,
the included or integrated fragments (8) are managed by the desktop manager (4) and are stimulated via a desktop interface (10), and
the process control of the management and weapon operation system is carried out by means of the desktop manager (4), using the included fragments (8) with their dialog algorithm.

12. Method according to claim 11,
wherein
a functional display of the procedure of the management and weapon operation system is output via the graphic control interface (2) on the display means, wherein the display can be updated in real time.
